(19) United States
(12) Patent Application Publication
(10) Pub. No.: US 2021/0070330 A1
(43) Pub. Date: Mar. 11, 2021

(54) LAMP ASSEMBLY, LAMP SYSTEM AND METHOD FOR OPERATING A LAMP SYSTEM

(71) Applicant: Siemens Mobility, Inc., New York, NY (US)

(72) Inventors: Richard Alan McGavock, JR., Columbia, MO (US); Brian Harp, New Albany, IN (US)

(21) Appl. No.: 17/053,249

(22) PCT Filed: Jun. 29, 2018
(86) PCT No.: PCT/US2018/040209

§ 371 Date: Nov. 5, 2020

(51) Int. Cl. B61L 5/18; H05B 45/10; H05B 39/10; H05B 47/18; F21V 23/04; H05B 47/19

(52) U.S. Cl. CPC B61L 5/189; H05B 45/10; H05B 47/19; H05B 47/18; F21V 23/0407; H05B 39/10

(57) ABSTRACT

A lamp system (200) includes a lamp assembly (210, 215) with a light source (212) coupled to a base (214), an electronic circuit (216) for operating the light source (212), and a switching device (218) for setting a flash rate of the light source (212). A lamp communication device (250) configured to transmit control signals to the lamp assembly (210). A communication network (260) interfaces with the lamp assembly (210) and the lamp communication device (250). The electronic circuit (216) is configured to operate the light source (212) in response to a control signal (262) transmitted by the lamp communication device (250) via the communication network (260), and in accordance with a set flash rate so that the light source (212) switches between an on state and an off state by default.

### BACKGROUND

### 1. Field

Aspects of the present disclosure generally relate to a lamp assembly, a lamp system and a method for operating a lamp system, for example for use in connection with railroad grade crossings and railroad crossing warning devices.

### 2. Description of the Related Art

Warning systems have been developed to warn people and cars of an approaching train at a railroad grade crossing. Railroad grade crossings, sometimes referred to in the U.K. as level crossings, are locations at which railroad tracks intersect roads. A constant warning time device, also referred to as a grade crossing predictor (GCP) in the U.S. or a level crossing predictor in the U.K., is an electronic device that is connected to the rails of a railroad track and is configured to detect the presence of an approaching train and determine its speed and distance from a railroad grade crossing. The constant warning time device, in combination with a crossing controller, will use this information to generate constant warning time signal(s) for controlling crossing warning device(s). A crossing warning device is a device that warns of the approach of a train at a crossing, examples of which include crossing gate arms (e.g., the familiar red and white striped wooden or fibreglass arms often found at highway grade crossings to warn motorists of an approaching train), crossing lights (such as the red flashing lights often found at highway grade crossings in conjunction with the crossing gate arms discussed above), and/or crossing bells or other audio alarm devices.

Existing crossing controllers flash crossing lamps directly and must accommodate multiple lamp models, which necessitates a complex and costly circuit board design. It also requires additional setup for an end user to program lamp voltages. Additionally, a single failure of the controlling relay in the control house can result in a railroad grade crossing with all lamps dark. Thus, there may exist a need to improve lamp control so that there is not a single component failure that will leave a dark railroad grade crossing.

### SUMMARY

Briefly described, aspects of the present disclosure relate to a lamp assembly, a lamp system and a method for operating a lamp system, for example for use in railroad crossing warning devices and railroad grade crossings.

A first aspect of the present disclosure provides a lamp assembly comprising a light source coupled to a base, an electronic circuit for operating the light source, and a switching device for setting a flash rate of the light source, wherein the electronic circuit is configured to operate the light source in response to an activation signal and in accordance with a set flash rate so that the light source switches between an on state and an off state by default.

A second aspect of the present disclosure provides a lamp system comprising a lamp assembly comprising a light source coupled to a base, an electronic circuit for operating the light source, and a switching device for setting a flash rate of the light source, a lamp communication device configured to transmit control signals to the lamp assembly, and a communication network interfacing with the lamp assembly and the lamp communication device, wherein the electronic circuit is configured to operate the light source in response to a control signal transmitted by the lamp communication device via the communication network, and in accordance with a set flash rate so that the light source switches between an on state and an off state by default.

A third aspect of the present disclosure provides a method for operating a lamp system comprising installing a lamp assembly comprising a light source coupled to a base, an electronic circuit for operating the light source, and a switching device for setting a flash rate of the light source, transmitting an activation signal by a lamp communication device to the lamp assembly via a communication network, and flashing the light source according to a set flash rate in response to a received activation signal.

### BRIEF DESCRIPTION OF THE DRAWINGS

FIG. 1 illustrates a schematic of a railroad grade crossing in accordance with an exemplary embodiment of the present disclosure.

FIG. 2 illustrates a schematic of a lamp system comprising a lamp assembly in accordance with an exemplary embodiment of the present disclosure.

FIG. 3 illustrates a schematic of a further lamp assembly in accordance with an exemplary embodiment of the present disclosure.

FIG. 4 illustrates a schematic of a wireless configuration of a lamp system in accordance with an exemplary embodiment of the present disclosure.

FIG. 5 illustrates a schematic of a wired configuration of a lamp system in accordance with an exemplary embodiment of the present disclosure.

FIG. 6 illustrates a flow chart of a method for operating a lamp system in accordance with an exemplary embodiment of the present disclosure.

### DETAILED DESCRIPTION

To facilitate an understanding of embodiments, principles, and features of the present invention, they are explained hereinafter with reference to implementation in illustrative embodiments. In particular, they are described in the context of being a lamp assembly, a lamp system and a method for operating a lamp system. Embodiments of the present invention, however, are not limited to use in the described devices or methods.

The components and materials described hereinafter as making up the various embodiments are intended to be illustrative and not restrictive. Many suitable components and materials that would perform the same or a similar function as the materials described herein are intended to be embraced within the scope of embodiments of the present invention.

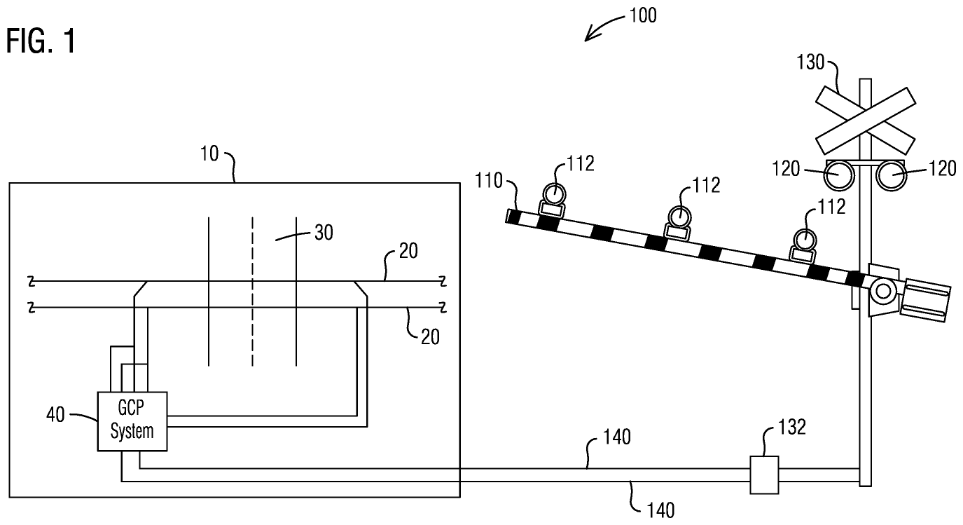

FIG. 1 illustrates a schematic of a railroad grade crossing 100 in accordance with an exemplary embodiment of the present disclosure. The railroad grade crossing 100 is provided at a location in which a road 30 crosses a railroad track 20.

FIG. 1 illustrates multiple railroad crossing warning devices, also referred to as grade crossing warning devices, which warn of the approach of a train at the crossing of the road 30 and the railroad track 20, i.e., a railroad crossing. The railroad crossing warning devices include for example a crossing gate arm 110 with (or without) gate arm lights 112 spaced along the arm 110, crossing lamps (or lights) 120, a railroad crossbuck 130, and/or other devices not illustrated herein, as for example crossing bells or other audio alarm devices. The crossing warning devices are in communication with a grade crossing predictor (GCP) system 40 via connecting elements 140, which are for example electric cables. It should be noted that the components are illustrated schematically and are not drawn to scale, in particular are not drawn to scale in relation to each other.

The GCP system 40 is configured to detect the presence of an approaching train, determine its speed and distance from the railroad crossing, calculates when the train will arrive at the crossing, and will use this information to generate constant warning time signals for controlling the crossing warning devices 110, 112, 120, 130. Typically, a crossing controller, which can be for example a normally energized master relay 132, only shown schematically herein, is arranged between the GCP system 40 and the warning devices 110, 112, 120, 130, for example along the connecting elements 140 and operably coupled by the connecting elements 140, wherein an output of the GCP system 40 feeds a coil of the master relay 132. According to a pre-programmed time, for example a number of seconds and/or minutes, before projected arrival time of the approaching train, the GCP system 40 is configured such that the output feeding the coil of the master relay 132 is turned off to drop the master relay 132 and to activate the crossing warning devices 110, 212, 120, 130. Other configurations of a crossing controller are possible. It should be noted that the GCP system 40, the master relay 132 (crossing controller) and the warning time devices 110, 112, 120, 130 will not be described in further detail as those of ordinary skill in the art are familiar with these devices and systems.

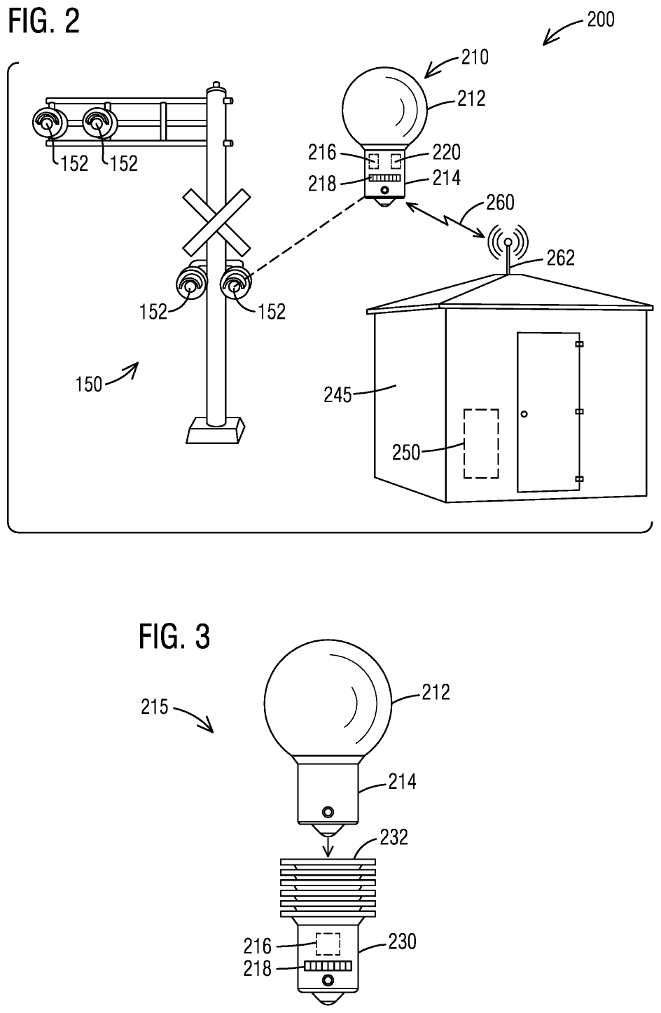

FIG. 2 illustrates a schematic of a lamp system 200 in accordance with an exemplary embodiment of the present disclosure. The lamp system 200 can be used in a railroad crossing warning system, for example in connection with railroad crossing warning device 150 comprising multiple crossing lights 152. However, it should be noted that the described lamp system 200 and lamp assembly 210 can be used not only for railroad crossing warning devices, but for many other light or lamp applications, for example road traffic or warning lights, within industrial facilities, airport facilities or within building technology applications.

The lamp system 200 comprises lamp assembly 210. Lamp assembly 210 can be used for one or more of the crossing lights 152. The lamp assembly 210 comprises a light source 212 coupled to a base 214. According to an exemplary embodiment of the present disclosure, the lamp assembly 210 itself comprises circuitry, e.g., electronic circuit 216, for independently flashing the light source 212. As noted before, existing crossing lamps, such as lamps 120, are simply flashed by a crossing controller (in connection with a GCP) and provides control signals to the crossing lamps 120. In contrast, the provided lamp assembly 210 is not flashed by a crossing controller but uses a lamp (light source 212) that flashes independently without the need for a traditional crossing controller. Rather, the electronic circuit 216 is configured to operate the light source 212 in response to an activation signal and in accordance with a set flash rate so that the light source 212 switches between an on state and an off state by default. Thus, the lamp assembly 210 comprises a switching device 218 for setting a flash rate of the light source 212.

According to an embodiment, as illustrated in FIG. 2, the base 214 comprises the electronic circuit 216 and the switching device 218 for setting the flash rate. Specifically, the electronic circuit 216 is positioned inside the base 214, for example inside a housing of the base 214. Further, the switching device 218 is positioned so that a user or operator of the lamp assembly 210 can operate or use the switching device 218 and set a specific flash rate for the light source 212. The switching device 218 is connected to the electronic circuit 216 inside the base 214, so that the electronic circuit 214 operates the light source 212 according to a set flash rate.

In an example, the switching device 218 comprises a dip switch. A dip switch provides a simple and inexpensive solution to select an operating mode (flash rate) of the light source 212. In accordance with regulations of the Federal Railroad Administration (FRA), the switching device 218 is configured to set a flash rate between 35 flashes per minute and 65 flashes per minute. Further, the switching device 218 is configured to set the light source 212 as a member of a first flash cycle or a second flash cycle to generate alternating flashes.

As noted before, the electronic circuit 216 is configured to operate the light source 212 in response to an activation signal or control signal. Such an activation signal or control signal is provided and transmitted to the lamp assembly 210 by a lamp communication device 250. For the lamp assembly 210 to communicate, which comprises at least receiving, the lamp assembly 210 comprises a data connection 220. The data connection 220 can be configured for wired or wireless communication. Further, lamp system 200 comprises a communication network 260, wired or wireless, interfacing with the lamp assembly 210 and the lamp communication device 250.

If communication is wireless, the lamp assembly 210 comprises for example an air interface, e.g. Wi-Fi, to communicate wirelessly for example via Internet. Alternatively, if communication is wired, the lamp assembly 210 comprises a wired connection to the lamp communication device 250, for example via cables.

The lamp communication device 250 may be embodied as software or a combination of software and hardware. The lamp communication device 250 may be an existing device programmed to interact with the lamp assembly 210. For example, the lamp communication device 250 may be incorporated into an existing wayside control device, for example constant warning device or crossing controller, by means of software. The lamp communication device 250 may be a module programmed into an existing crossing controller.

As illustrated in FIG. 2, a crossing bungalow 245, which is typically located close to a railroad grade crossing, may house the lamp communication device 250. The crossing bungalow 245 typically includes equipment and devices necessary for controlling a grade crossing, such as for example GCP and crossing controller. An antenna 262, for example mounted on the crossing bungalow 245 if the lamp communication device 250 is located in the crossing bungalow 245, can be used for a wireless communication between the lamp communication device 250 and lamp assembly 210. Alternatively, the lamp communication device 250 may be located remotely to the grade crossing, for example at a central train operator station or a rail operations center. In such a case, activation signals or control signals are transmitted wirelessly by the lamp communication device 250 to the lamp assembly 210.

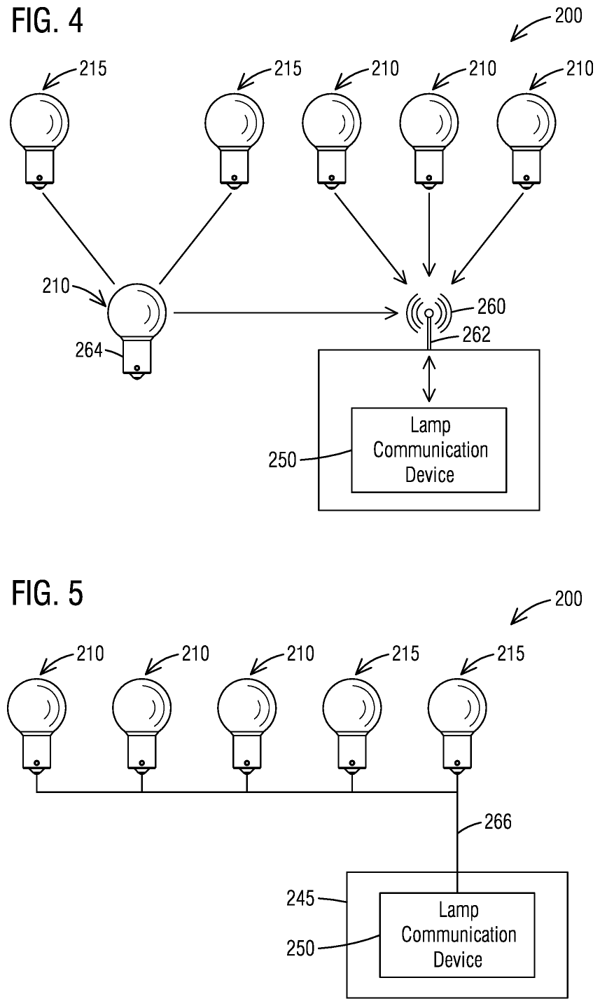

Typically, a grade crossing and/or crossing warning devices comprises multiple lamp assemblies 210, wherein the lamp communication device 250 is configured to provide the clock syncing, health checks and activation signals of one or more lamp assemblies 210. Further configurations of the lamp system 200 will be described with respect to FIG. 4 and FIG. 5.

In an embodiment, the light source 212 comprises a light emitting diode (LED) and the base 214 comprises a LED circuit board. Using one or more LEDs provides smart and low power lamps. Alternatively, the light source 212 can comprise an incandescent light bulb. Thus, existing devices, such as crossing warning devices, with incandescent light bulbs can be retrofitted to achieve or accomplish the light assembly 210.

FIG. 3 illustrates a schematic of a further lamp assembly 215 in accordance with an exemplary embodiment of the present disclosure. The lamp assembly 215 differs from the lamp assembly 210 as illustrated in FIG. 2 in that the electronic circuit 216 and the switching device 218 are housed in a separate electronic module 230 and not in the base 214. The electronic module 230 is an ‘add-on’ module housing the circuit 216 for operating, i.e. flashing, the light source 212, and the switching device 218. An add-on module is easy to replace, for example when the module 230 is faulty or malfunctioning, without having to replace the lamp 210 because of the modular configuration. The module 230 can be replaced with an identical module 230 (having the same functionalities) or with a different module having different functionalities.

In an embodiment, the electronic module 230 is configured as a separate nesting module comprising an opening 232 for inserting the base 214 into the module 230 so that the light source 212 is in communication with the module 230. In another embodiment, the module 230 can comprise a back-up batterie for operation of the light source 212, for example when regular power supply to the lamp assembly 215 is not available. For regular power supply of the lamp assembly 215, the module 230 provides pass-through power to the light source 212. In another embodiment, the electronic module 230 can be a daughter board stacked on a LED circuit board when the light source 212 comprises one or more LEDs.

Instead of the base 214, the module 230 can be adapted to communicate with the lamp communication device 250 wired or wireless. If communication is wireless, the module 230 comprises for example an air interface, e.g. Wi-Fi, to communicate wirelessly for example via Internet. If communication is wired, the module 230 comprises a wired connection to the lamp communication device 250, for example via cables.

FIG. 4 illustrates a schematic of a wireless configuration of lamp system 200 in accordance with an exemplary embodiment of the present disclosure.

Lamp system 200 typically comprises a plurality of lamp assemblies 210 and/or 215. FIG. 4 illustrates a combination of lamp assemblies 210 and 215. The lamp communication device 250 communicates with the plurality of lamp assemblies 210, 215 wirelessly via communication network 260, for example Internet. A high activation signal from the lamp communication device 250 will set the lamp assemblies 210, 215 to an OFF state. A low activation signal due to a train on approach or crossing device failure will cause the lamp assemblies 210, 215 to revert back to their default flashing state in sync with either the A of B flash cycle.

In a first embodiment, the lamp communication device 250 can directly communicate with the lamp assemblies 210 and/or 215, for example send activation signals for flashing directly to each lamp assembly 210 (see right section of FIG. 4). In a second embodiment, one of the plurality of lamp assemblies 210 can be set as wireless node 264. In this case, lamp communication device 250 transmits activation signals or control signals to the wireless node 264, wherein the wireless node 264 receives and transmits the activation or controls signals to associated lamp assemblies 215 (see left section of FIG. 4).

Further, the lamp assemblies 210, 215 are powered by a power supply. Traditionally, crossing lamps are powered by alternating current (AC) power via crossing equipment, for example the crossing controller. In addition, back-up batteries are installed allowing the lamps to function during a power failure. In an embodiment, the lamp assembly 210, 215 receive constant power from one or more power storage device(s), such as batteries, for example the existing back-up batteries. In another embodiment, the lamp assemblies 210, 215 can be powered by solar power utilizing solar panels installed in proximity and coupled to the lamp assemblies 210, 215. In an example, the lamp assemblies 210, 215 can be powered primarily by solar power, wherein existing back-up crossing batteries may be used as secondary power supply when solar power is not available.

FIG. 5 illustrates a schematic of a wired configuration of a lamp system 200 in accordance with an exemplary embodiment of the present disclosure. Instead of a wireless communication between the plurality of lamp assemblies 210, 215 and the lamp communication device 250 as illustrated in FIG. 4, the embodiment of FIG. 5 illustrates a wired communication via a data wire 266.

The configuration of FIG. 5 can be used for retrofitting existing systems. Existing crossing lights, such as the crossing lights 120 of FIG. 1, can be easily equipped (retrofitted) with the lamp assembly 210, 215 and system 200. As noted, traditionally, crossing lamps are powered via crossing equipment, for example the crossing controller, by AC power. Thus, three wires are required and present. In an embodiment, the lamp assemblies 210, 215 receive constant power from one or more power storage device(s), such as batteries, for example the existing back-up batteries. Thus, the system 200 requires only two wires for power, since batteries operate with direct current (DC), wherein the third existing wire can be used for data transmission via low power AC signal between the lamp assemblies 210, 215 and the lamp communication device 250.

The configuration of FIG. 5 may also be configured such that the lamp assemblies 210, 215 are powered by solar power utilizing solar panels installed in proximity and coupled to the lamp assemblies 210, 215. In an example, the lamp assemblies 210, 215 can be powered primarily by solar power, wherein existing back-up crossing batteries may be used as secondary power supply when solar power is not available.

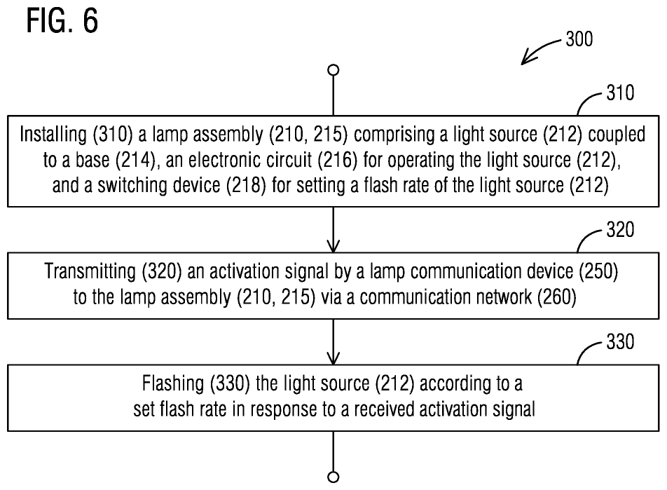

FIG. 6 illustrates a flow chart of a method 300 for operating a lamp system 200 in accordance with an exemplary embodiment of the present disclosure. Method 300 may utilize lamp system 200 and lamp assemblies 210, 215 as described with respect to FIGS. 2, 3, 4 and 5.

In a first step 310, a lamp assembly 210 or 215 is installed. The lamp assembly 210, 215 comprises a light source 212, a base 214, an electronic circuit 216 for operating the light source 212, and a switching device 218 for setting a flash rate of the light source 212 (see FIG. 2 or FIG. 3). The lamp assembly 210, 215 may be installed in a crossing warning device or in another application requiring lamp systems, for example in industry facilities, airport facilities or within building technology applications. In a second step 320, an activation signal is transmitted by a lamp communication device 250 to the lamp assembly 210, 215 via communication network 260. The activation signal is transmitted wired or wirelessly. After receiving the activation signal, the light source 212 flashes according to a set flash rate by default (step 330). The flash rate is set directly at the lamp assembly 210, 215, for example using a dip switch.

The lamp assembly 210, 215 flashes independently without the need of special control equipment. Lamp functions are being largely managed by the lamp assemblies 210, 215 themselves. Further, the lamp assembly 210, 215 includes an independent power supply, for example utilizing power storage devices, such as batteries, and/or solar power. The provided assemblies 210, 215 and system 200 cost significantly less than traditional systems, provide a simplified user experience, have a smaller footprint within the crossing bungalow, and reduce the risk of a dark crossing.

While embodiments of the present invention have been disclosed in exemplary forms, it will be apparent to those skilled in the art that many modifications, additions, and deletions can be made therein without departing from the spirit and scope of the invention and its equivalents, as set forth in the following claims.

1.-20. (canceled)

21. A lamp assembly comprising:
a light source coupled to a base,
an electronic circuit for operating the light source, and
a switching device for setting a flash rate of the light source,
wherein the electronic circuit is configured to operate the light source in response to an activation signal and in accordance with a set flash rate so that the light source switches between an on state and an off state by default.

22. The lamp assembly of claim 21, wherein the base comprises the electronic circuit for operating the light source and the switching device for setting the flash rate.

23. The lamp assembly of claim 21, wherein the switching device comprises a dip switch.

24. The lamp assembly of claim 21, wherein the switching device is configured to set a flash rate between 35 flashes per minute and 65 flashes per minute.

25. The lamp assembly of claim 21, wherein the switching device is configured to set the light source as a member of a first flash cycle or a second flash cycle to generate alternating flashes.

26. The lamp assembly of claim 21, further comprising a data wire connection for communicating with a lamp communication device.

27. The lamp assembly of claim 21, wherein the light source comprises a light emitting diode (LED) and the base comprises a LED circuit board.

28. The lamp assembly of claim 21, wherein the light source comprises an incandescent light bulb.

29. The lamp assembly of claim 21, further comprising an electronic module coupled to the light source and the base and comprising the electronic circuit and the switching device.

30. The lamp assembly of claim 29, wherein the electronic module is configured as a separate nesting module comprising an opening for inserting the base into the module.

31. The lamp assembly claim 29, wherein the electronic module is a daughter board stacked on a LED circuit board.

32. A lamp system comprising:
a lamp assembly comprising:
a light source coupled to a base,
an electronic circuit for operating the light source, and
a switching device for setting a flash rate of the light source,
a lamp communication device configured to transmit control signals to the lamp assembly, and
a communication network interfacing with the lamp assembly and the lamp communication device,
wherein the electronic circuit is configured to operate the light source in response to a control signal transmitted by the lamp communication device via the communication network and in accordance with a set flash rate so that the light source switches between an on state and an off state by default.

33. The lamp system of claim 32, wherein the communication network comprises a wired communication network.

34. The lamp system of claim 33, wherein data transmission of control signals is based on low power alternating current (AC) signals.

35. The lamp system of claim 32, wherein the communication network comprises a wireless communication network.

36. The lamp system of claim 32, comprising a plurality of lamp assemblies, wherein the lamp communication device is configured to transmit control signals directly to each individual lamp assembly.

37. The lamp system of claim 35, comprising a plurality of lamp assemblies, wherein at least one lamp assembly is configured as a wireless node, and wherein the lamp communication device is configured to transmit control signals to the wireless node, and wherein the wireless node is configured to receive and transmit the controls signals to associated lamp assemblies.

38. The lamp system of claim 32, wherein the lamp communication device is configured to provide clock syncing, health checks and activation signals of one or more lamp assemblies.

39. A method for operating a lamp system comprising:
installing a lamp assembly comprising
a light source coupled to a base,
an electronic circuit for operating the light source, and
a switching device for setting a flash rate of the light source,
transmitting an activation signal by a lamp communication device to the lamp assembly via a communication network, and
flashing the light source according to a set flash rate in response to a received activation signal.

40. The method of claim 39, wherein the activation signal is transmitted wirelessly by the lamp communication device to the lamp assembly.
